(19) United States
(12) Patent Application Publication
(10) Pub. No.: US 2019/0129961 A1
(43) Pub. Date: May 2, 2019

(54) SYSTEM AND METHOD FOR RANKING SEARCH RESULTS

(71) Applicant: Nutanix, Inc., San Jose, CA (US)

(72) Inventors: Atreyee Maiti, San Jose, CA (US); Himanshu Shukla, San Jose, CA (US); Piyush Nimbalkar, San Jose, CA (US); Rahul Singh, San Jose, CA (US); Ranjan Parthasarathy, San Jose, CA (US); Ziv Kennan, San Jose, CA (US)

(21) Appl. No.: 15/799,018

(22) Filed: Oct. 31, 2017

(51) Int. Cl. G06F 17/30

(52) U.S. Cl. CPC G06F 17/3053; G06F 17/3043; G06F 17/30554

(57) ABSTRACT

A system and method include receiving, by a search computing system of a virtual computing system, a search query via a search interface, converting the search query into a structured query that identifies at least one primary entity within the virtual computing system, and determining at least one related entity from the at least one primary entity. The system and method further include generating search results from the at least one primary entity and the at least one related entity, ranking the at least one primary entity and the at least one related entity by popularity, ranking the search results based on a criteria for each of the at least one primary entity and the at least one related entity while maintaining the popularity ranking, and displaying the ranked search results on the search interface.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with at least some aspects of the present disclosure, a method is disclosed. The method includes receiving, by a search computing system of a virtual computing system, a search query via a search interface, converting, by the search computing system, the search query into a structured query that identifies at least one primary entity within the virtual computing system, and determining, by the search computing system, at least one related entity from the at least one primary entity. The method also includes generating, by the search computing system, search results from the at least one primary entity and the at least one related entity, ranking, by the search computing system, the at least one primary entity and the at least one related entity by popularity, and ranking, by the search computing system, the search results based on a criteria for each of the at least one primary entity and the at least one related entity while maintaining the popularity ranking. The method further includes displaying, by the search computing system, the ranked search results on the search interface.

In accordance with some other aspects of the present disclosure, a system is disclosed. The system includes a search computing system of a virtual computing system. The search computing system includes a database configured to store structured data related to a structured query generated from a search query and an entity relationship graph, and a processing unit configured to receive the search query via a search interface, convert the search query into the structured query that identifies at least one primary entity within the virtual computing system, and determine at least one related entity of the at least one primary entity from the entity relationship graph. The processing unit is further configured to generate search results from the at least one primary entity and the at least one related entity, rank the at least one primary entity and the at least one related entity by popularity, rank the search results based on a criteria for each of the at least one primary entity and the at least one related entity while maintaining the popularity ranking, and display the ranked search results on the search interface.

In accordance with some other aspects of the present disclosure, another method is disclosed. The method comprises receiving, by a search computing system of a virtual computing system, a search query via a search interface, converting, by the search computing system, the search query into a structured query that identifies at least one primary entity within the virtual computing system, wherein the structured query includes a timeline, and determining, by the search computing system, at least one related entity from the at least one primary entity. The method further includes generating, by the search computing system, search results from the at least one primary entity and the at least one related entity satisfying the timeline, arranging, by the search computing system, the at least one primary entity and the at least one related entity in an order of popularity by arranging a counter value associated with each of the at least one primary entity and the at least one related entity from a highest value to a lowest value, and ranking, by the search computing system, the search results for each of the at least one primary entity and the at least one related entity starting with the most popular primary entity and the most popular related entity based on a criteria. The method additionally includes displaying, by the search computing system, the ranked search results on the search interface.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 is a block diagram of a search computing system of the virtual computing system of FIG. 1, in accordance with some embodiments of the present disclosure.

FIG. 3 is block diagram of a result generator of the search computing system of FIG. 2, in accordance with some embodiments of the present disclosure.

FIG. 4 is a first example of an entity relationship graph, in accordance with some embodiments of the present disclosure.

FIG. 5 is a second example of the entity relationship graph, in accordance with some embodiments of the present disclosure.

FIG. 6 is a third example of the entity relationship graph, in accordance with some embodiments of the present disclosure.

FIG. 7 is an example flowchart outlining operations for generating and ranking search results using the result generator, in accordance with some embodiments of the present disclosure.

FIG. 8 is an example flowchart outlining operations for ranking the search results, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a search computing system of a virtual computing system. The search computing system includes a query parser for parsing the search query and a result generator for gathering search results using the parsed search query. The result generator may include a primary results generator that is configured to gather search results from a primary entity identified from the parsed search query. The result generator may also include a related results generator that is configured to gather search results from related entities, or in other words, from entities that are related to the primary entity. The result generator may also include a ranking system that is configured to identify the entities (whether primary or related) that are most frequently searched and rank the search results in the order of that popularity. The ranking system may further be configured to additionally rank the search results for each entity ranked by popularity.

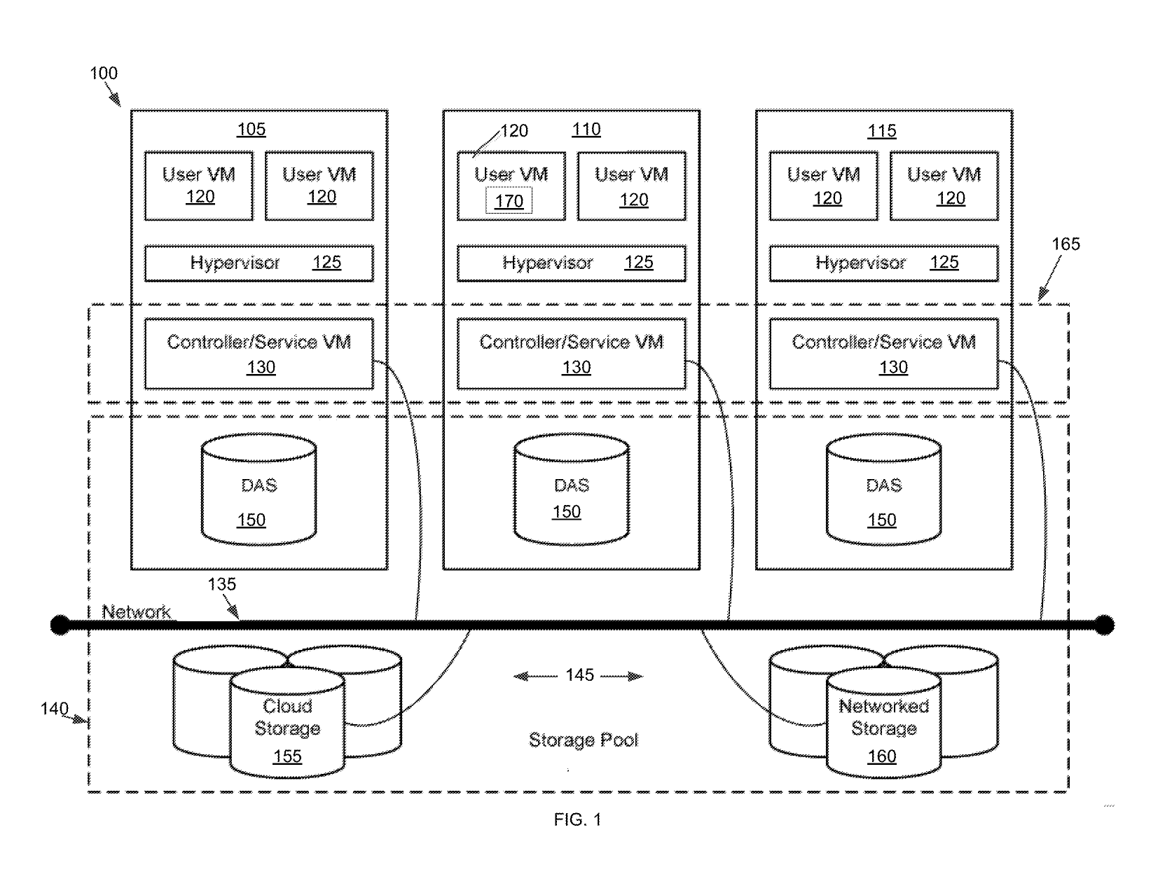

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and/or the third node 115.

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120 that are part of a cluster may be configured to share resources with each other. In some embodiments, multiple clusters may share resources with one another.

Further, as shown herein, one or more of the user VMs 120 may be configured to have a search computing system 170. In some embodiments, the search computing system 170 may be provided on one or more of the user VMs 120 of the leader node, while in other embodiments, the search computing system 170 may be provided on another node. In some embodiments, the search computing system 170 may be provided on a user virtual machine that is separate from but associated with the user VMs 120. For example, in some embodiments, the search computing system 170 may be provided on a user virtual machine that is configured to manage the various clusters and elements within the various clusters of the virtual computing system 100. In some embodiments, the search computing system 170 may reside on the controller/service VM 130. Thus, the search computing system 170 may be configured to reside on a variety of components within the virtual computing system 100 as desired.

The search computing system 170 may be configured to access the resources (e.g., storage, processing unit, etc.) of at least the user VM on which the search computing system is installed. In some embodiments, the search computing system 170 is configured to access the resources of the cluster within which the search computing system resides. Although the search computing system 170 has been shown in FIG. 1 as being provided on one of the user VMs 120, in some embodiments, the search computing system may be provided on multiple user VMs. In yet other embodiments, the search computing system 170 may be provided on a computing machine that is outside of the first node 105, the second node 110, and the third node 115, but connected to those nodes in operational association. In some such embodiments, the computing machine on which the search computing system 170 is provided may be either within the virtual computing system 100 or outside of the virtual computing system and operationally associated therewith. Generally speaking, the search computing system 170 may be connected to for receiving data from one or more clusters within the virtual computing system 100. Thus, either a single instance of the search computing system 170 or multiple instances of the search computing system, with each search computing system instance being connected to one or more clusters may be provided.

Furthermore, the search computing system 170 may be used to receive search queries from a user and provide results back to the user in response to the received search queries. The search results may correspond to data received back from the components of the cluster(s) that are connected to and communicating with the search computing system 170.

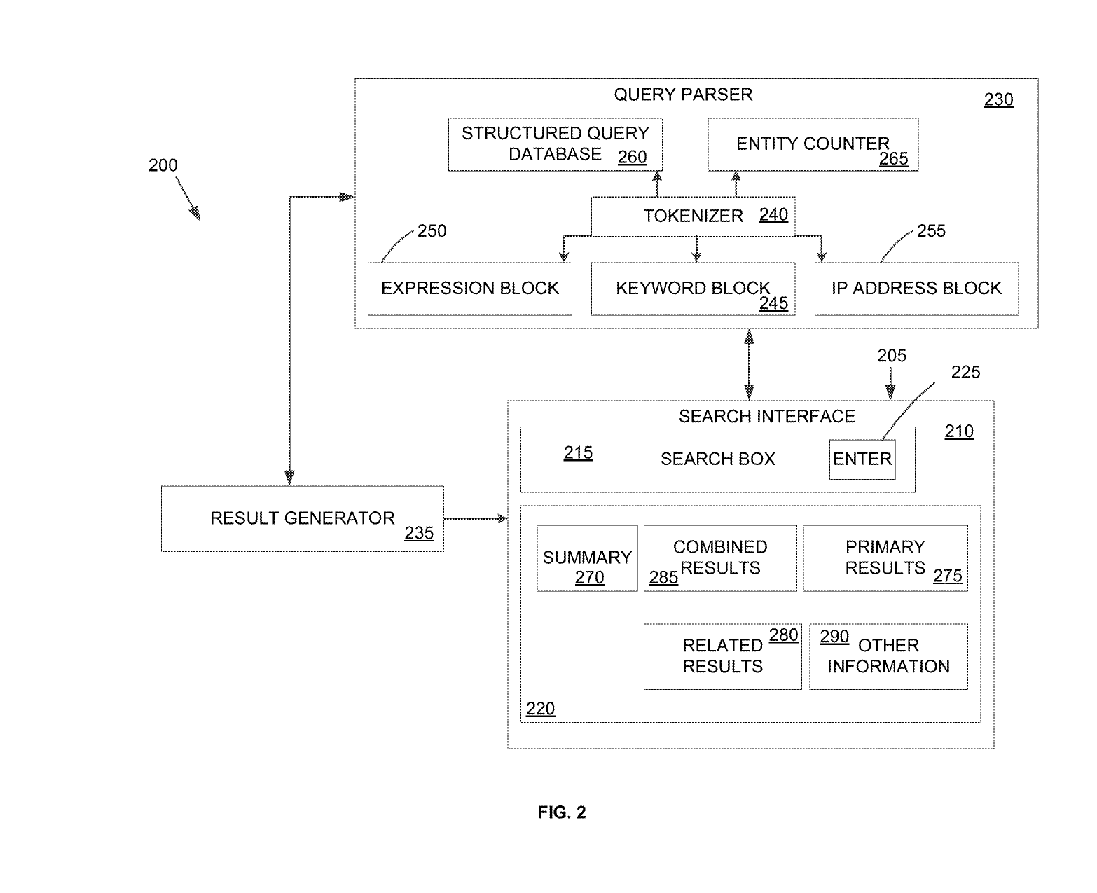

Turning to FIG. 2, a search computing system 200 is shown, in accordance with some embodiments of the present disclosure. The search computing system 200 is configured to receive search queries from a user and provide search results back to the user. The search computing system 200 is a contextual search system that identifies the context of a search query and particularly, identifies the intent of the user in running the search query. The search computing system 200 may identify the intent of the user by analyzing the search query, as detailed below, to determine whether the user is in a troubleshooting mode, exploration mode, a management mode, or another type of work flow mode. The search computing system 200 may return results back based upon the identified intent of the user.

The search computing system 200 includes a search interface 205 that is configured to receive the search queries from the user and return the search results back to the user. The search interface 205 includes a user interface 210 having a search box 215 for receiving search queries from the user and a search display box 220 for displaying the corresponding search results. Thus, the user interface 210 is configured to receive information from and provide information back to the user. The user interface 210 may be any suitable user interface. For example, the user interface 210 may be an interface for receiving user input and/or machine instructions for entry into the search box 215. The user interface 210 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as the user, to enter information into the search box 215.

The user interface 210 may also be configured for presenting information from the search computing system 200 to external systems, users, memory, etc. For example, the user interface 210 may display the search results within the search display box 220. Alternatively or additionally, the user interface 210 may include an interface for a printer, speaker, alarm/indicator lights, etc. to provide the search results. The user interface 210 may be provided on a color display, a cathode-ray tube (CRT), a liquid crystal display (LCD), a plasma display, an organic light-emitting diode (OLED) display, etc. It is to be understood that only certain features of the user interface 210 are shown herein. Nevertheless, in other embodiments, other features that are commonly provided on user interfaces and particularly, on user interfaces used in a virtualization environment (e.g., the virtual computing system 100) may be provided. For example, in some embodiments, the user interface 210 may include navigational menus, adjustment options, adjustment settings, adjustment display settings, etc.

The user inputs a search query into the search box 215 and interacts with (e.g., click, press-and-hold, roll or hover over, etc.) a search button 225 to send the search query for further processing and retrieval of search results. The user may input the search query in a variety of configurations. For example, in some embodiments, the user may input the search query in the form of keywords. Keywords are pre-defined terms or phrases that are understood by the search computing system 200. A list of all keywords understood by the search computing system 200 may be stored within a database that is accessible to the search computing system. The list of keywords may also be made available to the user.

Each keyword may be classified into one or more of four categories: entity type, properties, identifiers, and actions. “Entity type” keywords may include the different types of entities, such as, clusters, nodes, virtual machines, virtual disks, software applications, and other hardware, software, storage, virtual clouds, and data center components that make up the virtual computing system 100. Each “entity type” may include one or more “entities.” For example, in FIG. 1, each of the first node 105, the second node 110, and the third node 115 is an “entity” of “entity type” host machine.

“Properties” keywords include various attributes, values of attributes, and metrics/metric names associated with each entity type and/or entity. For example, each entity type may include one or more “properties” that may be same as, similar to, or different from the “properties” of the other entity types. In some embodiments, all of the entities included within a specific entity type may have the same properties. In other embodiments, the entities for a specific entity type may have at least some varying properties. Examples of “properties” keywords may include attributes such as type of operating system, number of processing units, number of storage units, IP address, etc. As noted above, “properties” keywords also include various metrics, such as processing unit utilization, disk space, latency, etc. Thus, the “properties” keywords identify the various hardware, software, and firmware features and characteristics of each entity and entity type.

“Identifiers” keywords may include identification information that may be used to uniquely identify an entity and/or entity type. For example, the “identifiers” keywords may include entity name (e.g., host name, cluster name, etc.), entity version, or any other identifying information that may be used to uniquely identify and distinguish one entity and/or entity type from another entity and/or entity type within a cluster.

“Actions” keywords include any actions that a particular entity and/or entity type may be authorized to perform. For example, “actions” keywords may include create, modify, delete, add, etc. that an entity and/or entity type may perform. The “actions” keywords may also include various work flow related tasks such as data recovery, capacity management, etc. that an entity and/or entity type may perform.

In addition to simple keywords, in some embodiments, the user may enter the search query in the form of an expression. Expressions may include phrases or keywords that are separated by an operator. The operator may be a symbol (e.g., =, >, <, etc.) or a subjective keyword (e.g., slow, high, low, top, greater than, less than, equal to, etc.). In some embodiments, the operator may also include advanced filter values (e.g., contains, does not contain, etc.). A valid expression includes a left hand side term and a right hand side term separated by the operator. In some embodiments, the left hand side term may be a keyword or a commonly used, “human friendly,” word. The right hand side term may be a value of the left hand side term. For example, an expression could be “version=5.0.” In this example, the left hand side term, “version,” may be a recognized keyword (or a commonly used term that may be translated into a recognized keyword by the search computing system 200) and the right hand side term, “5.0,” is a value of the left hand side term, “version.” Similar to the keywords, a list of all recognized operators may be stored within a database and be accessible to the search computing system 200, and potentially the user.

In some other embodiments, the user may enter an Internet Protocol (IP) address as the search query. In yet other embodiments, the user may simply use “human friendly” words to construct the search query, which may then be translated by the search computing system 200 into recognized keywords. Thus, the user may enter the search query in the form of keywords, expressions, IP addresses, “human-friendly” terms, or a combination thereof. The search interface 205 may also provide other features in the search box 215. For example, in some embodiments, the search box 215 may have an auto-complete feature, such that as the user is inputting (e.g., typing) the search query, the search interface suggests options to complete the query. The search box 215 may also suggest synonyms, alternate terms, and/or keywords that the user may use as part of the search query. Additional details pertaining to inputting of search queries are provided in U.S. application Ser. No. 15/143,060, filed on Apr. 29, 2016, the entirety of which is incorporated by reference herein.

The user interface 210 is configured to send information to and receive information from a query parser 230. Thus, upon interacting with the search button 225, the search query entered into the search box 215 is sent to the query parser 230. The query parser 230 parses the search query to convert the search query into a structured query for facilitating retrieval and compilation of search results in a result generator 235. To facilitate parsing of the search query and converting into a structured query, the query parser 230 includes a tokenizer 240, a keyword block 245, an expression block 250, and an IP address block 255. The keyword block 245 stores a list of all keywords that are recognized by the search computing system 200. Similarly, the expression block 250 stores a list of all recognized expressions, while the IP address block 255 stores a list of all recognized IP addresses. Although shown as separate components, in other embodiments, one or more of the keyword block 245, the expression block 250, and the IP address block 255 may be combined together. Further, one or more of the keyword block 245, the expression block 250, and the IP address block 255 may be stored within or be provisioned from the storage pool 140. In other embodiments, one or more of the keyword block 245, the expression block 250, and the IP address block 255 may be part of a database that is separate from the storage pool 140 but accessible to the search computing system 200.

Also, in some embodiments, the query parser 230 may include a correlation block (not shown) for converting any “human-friendly” words in the search query into recognized keywords, expressions, and/or IP addresses. In some embodiments, the correlation block may be part of one or more of the keyword block 245, the expression block 250, and/or the IP address block 255.

The query parser 230 receives the search query from the search interface 205 and converts that query into a structured query using the tokenizer 240. The tokenizer 240 of the query parser 230 breaks or tokenizes the search query and particularly, the characters of the search query, into a plurality of tokens. For each token, the tokenizer 240 parses that token into recognized keywords, expressions, and/or IP addresses. The tokenizer 240 may communicate with the keyword block 245, the expression block 250, and the IP address block 255 to parse the search query. The tokenizer 240 may also convert any “human-friendly” terms in the search query into recognized keywords. Additionally, although not shown, in some embodiments, the tokenizer 240 may also include or be in communication with additional components such as a ranking block to rank the identified keywords, a relationship block to identify relationships between the keywords, a matching block to match keywords and assign scores, etc. to facilitate conversion of the search query into the structured query. The structured query identifies one or more primary entities and one or more activity types.

As an example, if the search query input by the user is “V1 latency,” the tokenizer 240 may first tokenize the search query into two tokens, for example, a first token “V1” and a second token “latency.” For each token, the tokenizer 240 may access one or more of the keyword block 245, the expression block 250, the IP address block 255, and any other information that the tokenizer accesses to identify whether that token corresponds to a property such as a metric, an identifier such an entity name, an alert, etc. The tokenizer may further associate an entity and/or entity type with the identified property, identifier, alert, etc. Thus, the tokenizer 240 not only identifies the various keywords associated with each token, the tokenizer also identifies the category of those keywords.

For example, for the first token, “V1,” the tokenizer 240 may reference one or more of the keyword block, 245, the expression block 250, the IP address block 255, and any other information that the tokenizer has access to, and determine that the first token is likely an identifier (e.g., name) associated with a particular entity and/or entity type. Specifically, the tokenizer 240 may find references (e.g., by word matching and/or other mechanism) of “V1” within the keyword block 245, the expression block 250, the IP address block 255, etc. to identify all components that have “V1” as part of a keyword. For example, the tokenizer 240 may find that “V1” appears in the names of a specific cluster, a specific virtual machine, and a specific virtual disk. The tokenizer 240 may associate the specific cluster, virtual machine, and virtual disk that have “V1” in their names with the first token. These identified entities correspond to primary entities within the structured query.

Along with parsing the first token or after parsing the first token, the tokenizer 240 may parse the second token, “latency” in the search query “V1 latency.” Again, the tokenizer 240 may access the keyword block 245, the expression block 250, the IP address block 255, etc. to find (e.g., by word matching and/or other mechanism) references to “latency.” The tokenizer 240 may determine that “latency” is likely a keyword associated with a metric. Thus, the tokenizer 240 associates “latency” in the second token with an activity type in the structured query. In some embodiments, the activity type may include, for example, keywords associated with actions, properties, and identifiers, as discussed above. The activity type may also include alerts arising from the identified primary entity. For example, an activity type may be “CPU Utilization,” “latency,” etc.

In some embodiments, the activity type may also include a value for the activity type. For example, if the search query includes a value or a term that the tokenizer 240 associates as a value of an activity type, the tokenizer may include that identified value with the activity type. As an example, the activity type may say “CPU Utilization <50%,” “latency=6 seconds,” etc. It is to be understood that the types and values of activity types indicated above are simply an example. In other embodiments, a variety of types and values of the activity type are contemplated and considered within the scope of the present disclosure.

Thus, each structured query may include a combination of at least one primary entity and at least one activity type. For multiple primary entities and/or for multiple activity types identified by the tokenizer 240 during the parsing operation, multiple structured queries may be generated. For example, if the tokenizer 240 identifies a specific virtual disk and a specific virtual machine associated with the first token, “V1” in the search query “V1 latency,” one structured query may be <Entity Type (Virtual Machine), Entity (V1), Activity Type (latency)> and another structured query may be <Entity Type (Virtual Disk), Entity (V1), Activity Type (latency).” In other embodiments, a single structured query may be generated for all of the entities. In such embodiments and for first token, “V1” identified as a specific virtual machine and a specific virtual disk, the structured query may look like <Entity Type (Virtual Machine or Virtual Disk), Entity (V1), Activity Type (latency)>.

If the search query is not indicative of an entity or entity type, the tokenizer 240 may designate a default primary entity. Likewise, if the search query is not indicative of an activity type, the tokenizer 240 may designate a default activity type. In some embodiments, the tokenizer 240 may also associate a default value with the activity type.

It is to be understood that the format of the structured queries shown and described above is simply an example for purposes of explanation. The actual format of the structured queries may vary from one embodiment to another based upon the configuration of the search computing system 200. Further, it is to be understood that the search query “V1 latency” discussed above is also only an example for purposes of explanation. The search queries input by the user may take a variety of forms. Further, the search queries may include a single term or more than two terms in other embodiments. Thus, the tokenizer 240 is configured to receive and analyze search queries having a single token or greater than two tokens. Also, the actual format of the search queries, the format of the structured queries, the order in which the tokens are analyzed, etc. may vary from one embodiment to another. In some embodiments and particularly for more complex search queries, the tokenizer 240 may rank various tokens, generate token chains, etc., as described in greater detail in U.S. application Ser. No. 15/143,060, again, the entirety of which is incorporated by reference herein. Thus, the tokenizer 240 may generate one or more structured queries from each search query run by the user.

Each structured query generated by the tokenizer 240 provides a framework to the result generator 235 for retrieving the search results. Each structured query may also be stored within a structured query database 260 for future usage and reference. More specifically, the structured query is composed of structured data (e.g., the parsed information discussed above) and the structured data forming the structured query is stored within the structured query database 260. Although shown as a separate database, in some embodiments, the structured query database 260 may be part of the storage pool 140, the keyword block 245, the expression block 250, the IP address block 255, and/or another database within the search computing system 200. Each structured query may also be provided to the result generator 235.

The result generator 235 may be configured to access the storage pool 140, as well as any other database accessible to the result generator to gather search results corresponding to the structured query. For example, for the structured query of <Entity Type (Virtual Machine), Entity (V1), Activity Type (latency)>, the result generator 235 may access the virtual machine, V1, and gather the latency related data therefrom. Thus, for each structured query generated from a search query, the result generator 235 gathers the associated data. The result generator 235 may also identity entities that are related to the primary entity indicated in the structured query and gather data from those related entities as well, as discussed below. The result generator 235 may also aggregate, sort, and/or rank the gathered data and return that data to the search interface 205 for displaying within the search display box 220.

The search display box 220 may be configured to display the search results. In some embodiments, separate search display boxes may be provided within the user interface 210 for displaying various categories of search results. For example, in some embodiments, one display box in the user interface 210 may be provided for displaying search results obtained from the primary entity, a second display box may be provided for displaying the search results obtained from the related entities, and a third display box may be provided for search results obtained by combing the search results from both the primary and related entities. In other embodiments, the search display box 220 may be configured such that on a single search display box, all of the categories of search results are displayed (e.g., one at a time or simultaneously in different portions of the display box). Thus, the search display box 220 may be configured in a variety of ways as desired.

In some embodiments, the search display box 220 may be divided into boxes, such as a summary box 270, a primary results box 275, a related results box 280, a combined results box 285, and other information box 290. The summary box 270 may display an overall summary of primary search results (e.g., search results from the primary entity) and related search results (e.g., search results from the related entities), the primary results box 275 may display the primary search results received from the result generator 235, the related results box 280 may display the related search results received from the result generator, the combined results box 285 may display a combination of the primary and related search results, and the other information box 290 may list any other pertinent data that may have been uncovered during the search.

Further, the results displayed within each of the summary box 270, the primary results box 275, the related results box 280, the combined results box 285, and the other information box 290 may or may not be interactive. If interactive, the user may interact with (e.g., click) a particular item within those boxes to view/access additional information related to that item. Some of the boxes may be empty if there are no results to display.

Furthermore, in some embodiments, the configuration of the search display box 220 may change based upon the category of search results that are desired to be displayed. For example, when combined search results are desired, as indicated above, a configuration setting that may be user or system defined may be used to generate combined search results by combining the primary search results with the related search results. Along with generating combined search results, the search computing system 200 may also simultaneously configure the search display box 220 to display the combined search results (e.g., by generating a separate combined search results box). In some embodiments, the search computing system 200 may configure the search display box 220 to display the combined search results within the other information box 290.

Similarly, if only the primary search results and the combined search results are desired to be displayed within the search display box 220, the search computing system 200 may be configured to disable or remove the related results box 280 and provide a combined search box (or use the other information box 290). Thus, the configuration of the search display box 220 may vary based upon the search results that are desired to be displayed.

Although the summary box 270, the primary results box 275, the related results box 280, the combined results box 285, and the other information box 290 are shown herein, in other embodiments, additional, fewer, or different boxes may be displayed. For example, in some embodiments, a help box may be included to help the user understand various search results and/or aid with other search related functionality, etc. Further, in some embodiments, the number and types of boxes, as well as the shape, size, arrangement, and other configuration of the boxes that are displayed within the search display box 220 may vary in other embodiments. Further, the information displayed within each of the boxes may vary from one embodiment to another.

Referring still to FIG. 2, the search computing system 200 and particularly the query parser 230 includes an entity counter 265. The entity counter 265 keeps track of a popularity of a specific entity (e.g., primary entity). “Popularity” as used herein means a number of times or frequency with which a particular entity has been searched by the user. An entity that has been searched a greater number of times compared to other entities is more popular than the other entities. The entity counter 265 may be configured to track the popularity of either the primary entities, the related entities, or both. The configuration of the entity counter 265 to track the primary entities, the related entities, or both may be user defined and/or system defined. For example, in some embodiments, a default system defined configuration may be assigned to the entity counter 265, which may then be changed by the user as desired. The other user and/or system defined configurations described herein may be structured in a similar way.

Thus, the entity counter 265 may receive the structured query from the tokenizer 240 and identify the primary entity from the structured query. In other embodiments, the entity counter 265 may directly receive the identity of the primary entity from the tokenizer 240. On receiving the primary entity, the entity counter 265 may increase a counter associated with that primary entity. If a primary entity does not have a counter associated therewith in the entity counter 265, the entity counter may assign and increment a counter for the primary entity when the entity counter encounters that primary entity for the first time.

Similarly, the entity counter 265 may keep track of the related entities. In some embodiments, the entity counter 265 may receive an identity of the related entities from the result generator 235 for tracking the related entities. For example, when the result generator 235 identifies one or more related entities from a primary entity, the entity counter 265 may be configured to either increase a counter associated with those one or more related entities, or assign and increment a counter to those one or more related entities that previously did not have a counter assigned thereto.

Further, in some embodiments, the entity counter 265 may be configured to separately track the primary entities and the related entities such that by reviewing the counters, the identity of a most popular primary entity and identity of a most popular related entity may be determined. In other embodiments, in addition to or instead of separately tracking the popularity of the primary entities and the related entities, the entity counter 265 may combine the popularities of the primary entities and the related entities. In such embodiments, the counters for the primary entities and the counters for the related entities may be interleaved such that by reviewing the counters, a most popular entity amongst the primary and related entities may be determined. Thus, the entity counter 265 may be configured in a variety of ways.

Therefore, entities (whether primary or related) having a higher count value of the counters than other entities may be considered to be more frequently searched, or in other words more popular, than the entities with the lower count. The result generator 235 may use the count value from the various counters in ranking the search results from the primary and the related entities. Although the entity counter 265 has been shown as being part of the query parser 230, in other embodiments, the primary entity counter may be located outside of the query parser and in operational association therewith. In some embodiments, the entity counter 265 may be part of the tokenizer 240, the result generator 235, or another component of the search computing system 200 or the virtual computing system 100.

By virtue of keeping tracking the various entities, the entity counter 265 easily identifies the primary and related entities that are more frequently searched than other primary or related entities. Some entities may be more frequently searched than other entities for a variety of reasons. For examples, entities that are more problematic (e.g., raise more alerts or have more issues) may be searched more than other entities. Entities that are newly created may be searched more than other entities to identify any operational issued with the newly created entities, and so on. Entities that are more frequently searched in the past are also more likely to be searched more in the future.

Thus, by keeping track of the popularity of the entities, the results from the popular entities may be prioritized and ranked higher than results from other entities. By ranking according to popularity, search results that are more relevant to a user may be displayed higher up in the list of search results, thereby saving time that the user time may have otherwise spent in searching for that entity. Thus, searches may be more effectively performed.

It is to be understood that only certain components of the search computing system 200 are shown and discussed herein. Nevertheless, other components that are required to perform the functions described herein or desired to be included in the search computing system are contemplated and considered within the scope of the present disclosure.

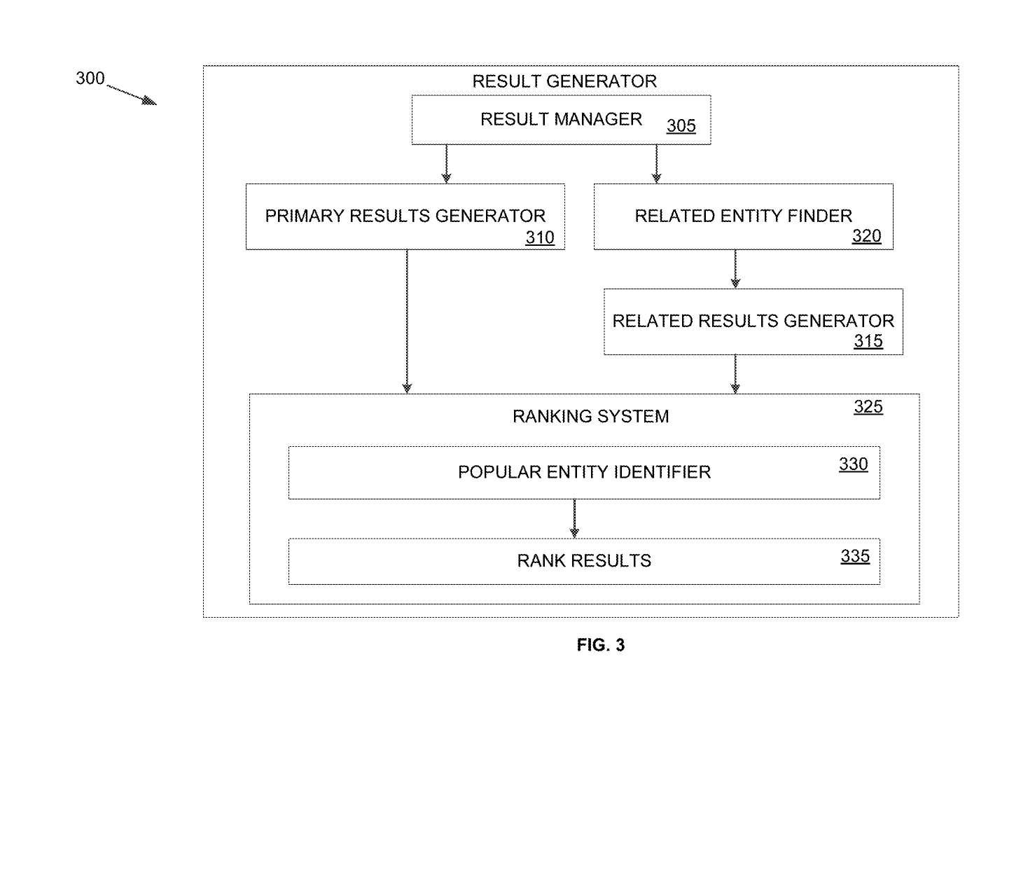

Referring now to FIG. 3, a block diagram of a result generator 300 is shown, in accordance with some embodiments of the present disclosure. The result generator 300 receives the structured query from the query parser 230 and gathers search results from the structured query. The result generator 300 includes a result manager 305 to manage the result gathering from the various entities in the virtual computing system 100, as well as manage the ranking of the gathered search results. The result generator 300 also includes a primary results generator 310 configured to gather search results or data from the primary entity identified in the structured query and a related results generator 315 configured to gather search results or data from the entities that are related to the primary entity.

Thus, the result manager 305 may receive the structured query from the query parser 230. Specifically, in some embodiments, the result manager 305 may receive the structured query from the query parser 230 and identify one or more primary entities and one or more activity types from the structured query. In other embodiments, instead of receiving the entire structured query and identifying the one or more primary entities and one or more activity types from the structured query, the result manager 305 may simply receive the identity of the one or more primary entities and one or more activity types from the query parser 230 corresponding to the structured query.

The result manager 305 may transfer the identity of the one or more primary entities and one or more activity types to the primary results generator 310. In other embodiments, the result manager 305 may simply provide the structured query to the primary results generator 310 and let the primary results generator identify the identity of the one or more primary entities and one or more activity types from the structured query. Upon receiving or determining the identity of the one or more primary entities and one or more activity types, the primary results generator 310 gathers data related to the activity type from each identified primary entity. For example, for a primary entity, “V1” and activity type, “latency,” the primary results generator 310 may gather latency related data from the V1 entity. The primary results generator 310 may transfer the gathered results to a ranking system 325. In some embodiments, the primary results generator 310 may use one or more entity relationship graphs for gathering the search results, as discussed below.

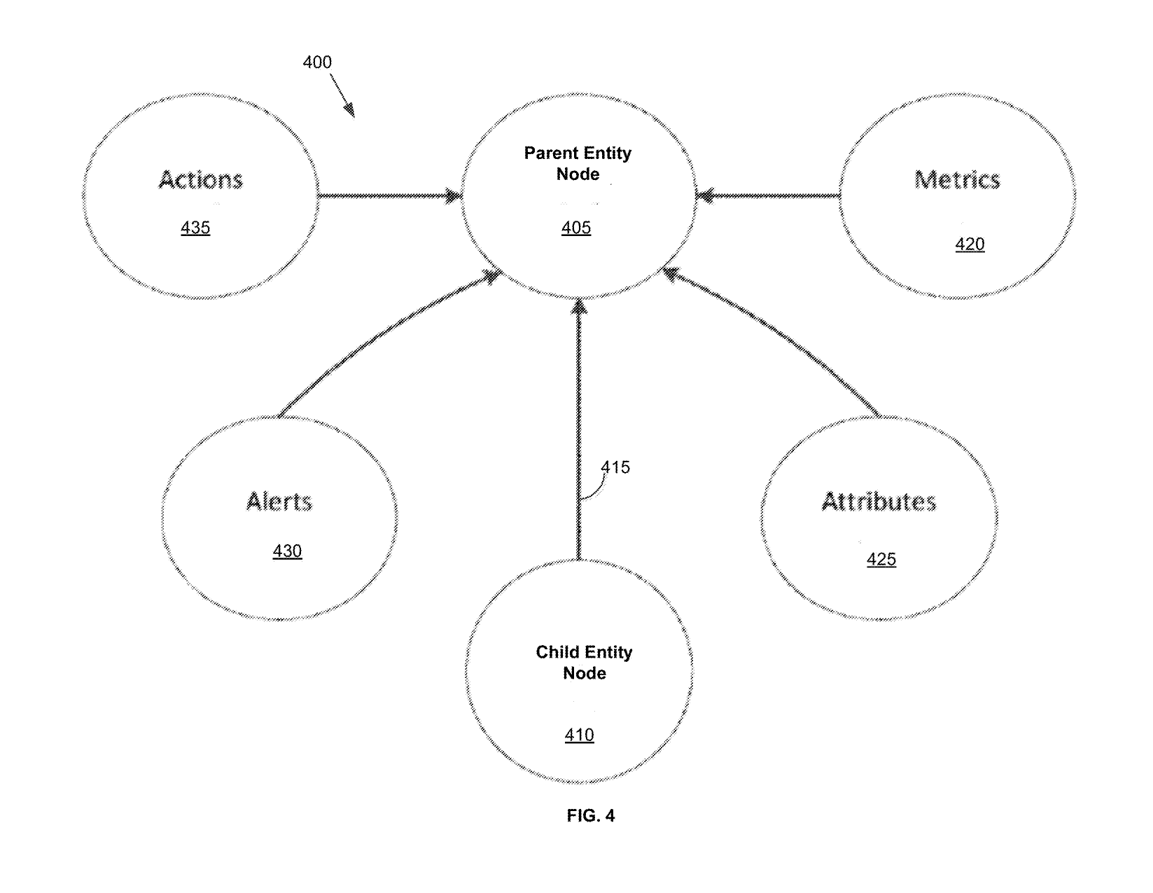

In some instances, the result manager 305 may also gather search results from entities that are related to the primary entity (also called related entities herein). To gather search results from the related entities, the result manager 305 may transfer the structured query and/or the identity of each primary entity to a related entity finder 320. The related entity finder 320 identifies the related entities by analyzing one or more entity relationship graphs. Examples of entity relationship graphs are shown in FIGS. 4-6.

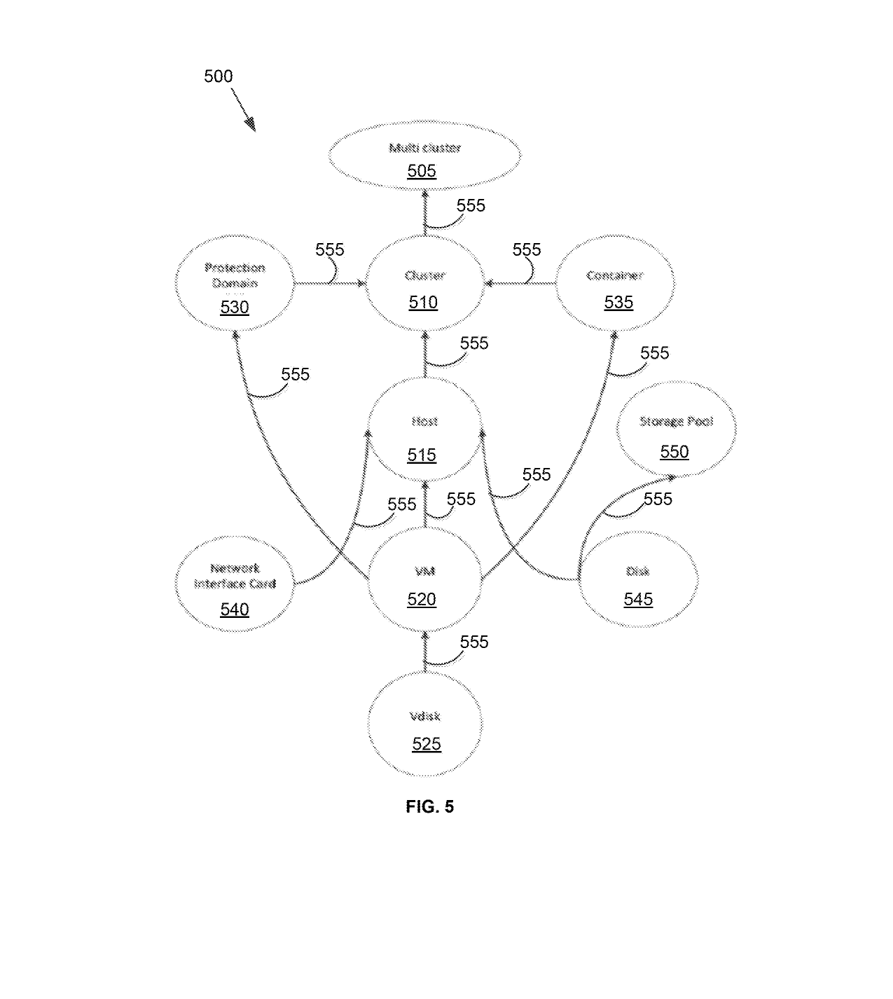

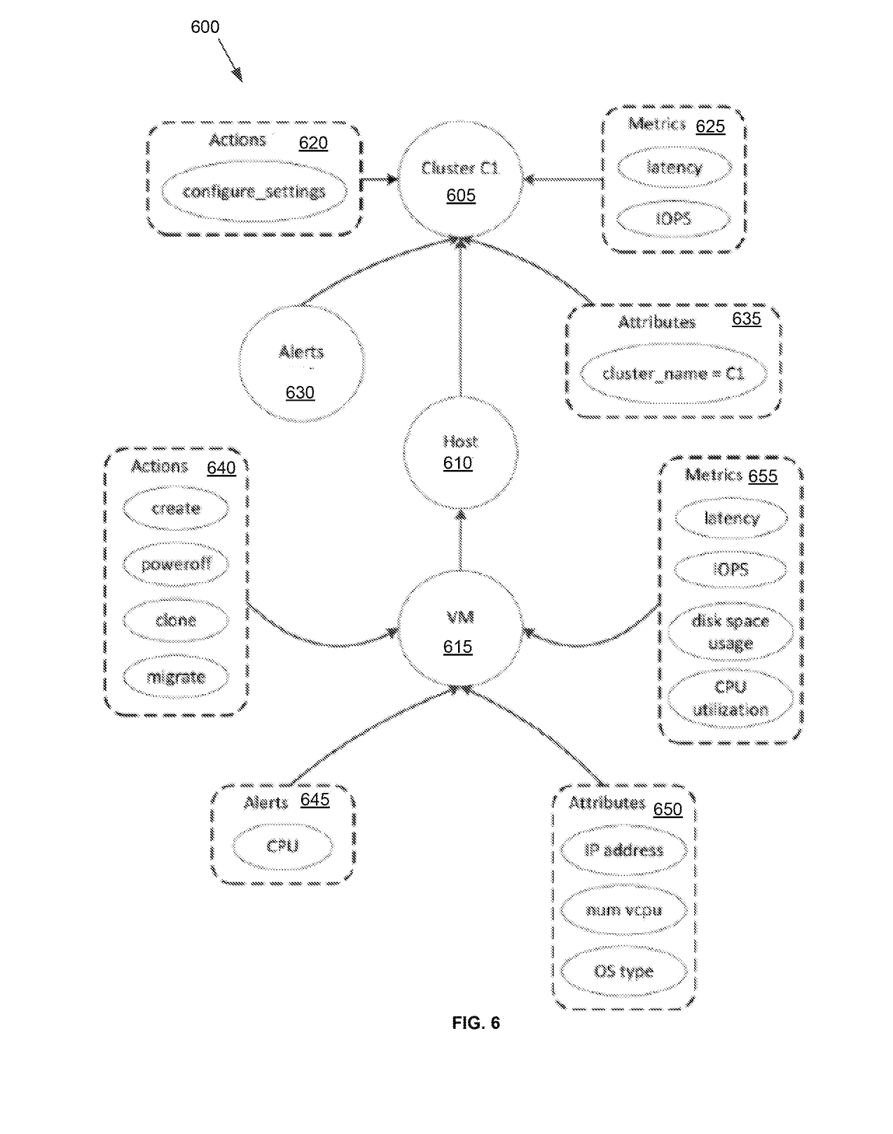

Referring to FIG. 4 in conjunction with FIG. 3, an entity relationship graph 400 is shown, in accordance with some embodiments of the present disclosure. The entity relationship graph 400 shows only the basic components that make up an entity relationship graph. FIGS. 5 and 6 provide more detailed examples of the entity relationship graph. The basic components of the entity relationship graph 400 are entity nodes and activity nodes. Entity nodes correspond to various entities within or associated with virtual computing system 100. An “entity” is any component within or associated with the virtual computing system 100 that is configured to be queried. All entities of the same kind may be classified as a particular “entity type.”

The various entities and entity types are related to one another in a hierarchical relationship. For example, all entity types may be related in a parent-child relationship. Likewise, all entities of a particular entity type may be related in a sibling relationship. Thus, the entity relationship graph 400 is organized in a tree-like structure with entity nodes connected to one another via links. Each entity node within the entity relationship graph 400 may be a parent node or a child node, and/or a sibling node. Each entity node has a single parent node, although some entity nodes (e.g., the nodes that are at the top of chain) may have no parent nodes. Also, a parent node may have multiple child nodes. For example, multiple host machines may exist within a cluster. Thus, the cluster may be a parent node and all of the host machines with that cluster may be child nodes. In other words, each host machine has a single parent node—the cluster, while the cluster has multiple child nodes (e.g., the host machines).

Further, all nodes on the same level of the tree structure are siblings. Thus, all host machines that are connected to the same cluster are siblings. In sum, for a host machine-cluster example, each host machine is a sibling to another host machine, as well as a child to the cluster. Similar parent-child and sibling relationships may exist between other components of the virtual computing system 100.

The entity relationship graph 400 shows a simplified parent-child relationship structure with two entity nodes: a single parent node and a single child node. For example, the entity relationship graph 400 shows that an entity node 405 is related to entity node 410 in a parent-child relationship, with the entity node 405 being a parent node and the entity node 410 being a child node. Direction of arrow 415 connecting the entity node 405 to the entity node 410 indicates a parent-child relationship (e.g., the arrow goes from the child node to the parent node). Although not shown, the entity node 405 may be connected to one or more additional child entities, each of which along with the entity node 410 would be sibling nodes of one another. Likewise, the entity node 405 may be a child node to another parent node, and the entity node 410 may be a parent node to other child(ren) node.

Further, as indicated above, each node in the entity relationship graph 400 may have one or more activity nodes associated therewith. Activity nodes are different from entity nodes. While the entity nodes represent the various entities within the virtual computing system 100, the activity nodes identify various attributes, actions, metrics, alerts, and other relevant information associated with a particular entity. Generally speaking, each entity node (e.g., the entity node 405 and the entity node 410) within the entity relationship graph 400 includes at least one activity node, although this need not always be the case. In some embodiments, the entity nodes (e.g., the entity node 405 and the entity node 410) may have no activity nodes associated therewith.

The entity relationship graph 400 shows an example of the activity nodes for the entity node 405. The entity node 405 is shown to have associated therewith four activity nodes, including a metrics node 420, an attributes node 425, an alerts node 430, and an actions node 435. Metrics, alerts, attributes, and actions are all keywords discussed above. Thus, the metrics node 420 may aggregate metrics related information for the entity associated with the entity node 405, the attributes node 425 may aggregate other property and identifier related information for the entity associated with the entity node 405, the alerts node 430 may collect all alerts arising from the entity associated with the entity node 405, while the actions node 435 may indicate what actions the entity associated with the entity node 405 may perform. Thus, the activity nodes correspond to the various categories of keywords discussed above, and each activity node may correspond to one or more categories of the keywords.

Although four activity nodes are shown associated with the entity node 405, in other embodiments, additional, fewer, or different activity nodes may be associated with the entity node 405. Similarly, although the entity node 410 is not shown as having any activity nodes, in other embodiments, the entity node 410 may also have one or more activity nodes. Generally speaking, the number and type of activity nodes associated with each entity within the entity relationship graph 400 may depend upon the entity type. For example, a node of entity type “cluster” may have different activity nodes than a node of entity type “virtual disk.” Likewise, the activity nodes for the various entities corresponding to a particular entity type may vary from one another in some embodiments based upon the configuration of the virtual computing system 100.

Further, it is to be understood that the entity relationship graph 400 is shown with only two entity nodes (e.g., the entity node 405 and the entity node 410) to simply explain the basic components of an entity relationship graph. In other embodiments, the entity relationship graph may include several entity nodes (or possibly a single entity node), with each entity node having one or more activity nodes (or possibly no activity nodes) depending upon the configuration of the virtual computing system 100. Moreover, in some embodiments, the components of the virtual computing system 100 may be broken down into subsets and each subset may be configured as an entity relationship graph. The entity relationship graphs of such subsets may or may not be connected to one another. Furthermore, the entity relationship graph 400 may be stored as part of the storage pool 140, part of a database within the search computing system 200, or another database or cloud accessible to the search computing system.

Turning now to FIG. 5 and referring to FIG. 5 in conjunction with FIGS. 3 and 4, another example of an entity relationship graph 500 is shown, in accordance with some embodiments of the present disclosure. The entity relationship graph 500 shows multiple entity nodes connected in a hierarchical parent-child relationship. For example, the entity relationship graph 500 shows a multi cluster node 505, a cluster node 510, a host node 515, a virtual-machine node 520, a virtual-disk node 525, a protection-domain node 530, a container node 535, a network interface card node 540, a disk node 545, and a storage pool node 550 connected in a parent-child relationship. It is to be understood that the various nodes shown in FIG. 5 are simply an example of the entity types that may be found within the virtual computing system 100. Depending upon the components of the virtual computing system 100 and how those components are connected to each other, the entity nodes and the relationship between the entity nodes may vary from one embodiment to another.

As shown in FIG. 5, the multi cluster node 505 is representative of all the clusters that may make up the virtual computing system 100. For example, if the virtual computing system 100 includes five clusters, the multi cluster node 505 represents all of the five clusters. Thus, each of the five clusters may be individually represented by an instance of the cluster node 510. Thus, the multi cluster node 505 and the cluster node 510 are connected in a parent-child relationship, with the multi cluster node being the parent node and the cluster node being the child node. Similarly, each of the cluster node 510 may be connected in a parent-child relationship with one or more of the host node 515, only one of which is shown herein. The host node 515 is representative of a host machine. Since each cluster may include one or more host machines, an instance of the host node 515 may be provided for each of those host machines. The cluster node 510 would then be the parent node and the host node 515 would be the child node.

Similar parent-child relationships, all of which are not described here individually, exist between the other nodes shown in FIG. 5. Generally speaking, a parent-child relationship between two entity nodes may be ascertained by looking at the direction of link or arrow 555 connecting two entity nodes. The head of the arrow 555 points to the parent. Thus, the arrow 555 leads from the child node to the parent node.

Further, certain entity nodes may not be related directly to one another but may be related indirectly via another entity node. For example, the virtual-machine node 520, which corresponds to a virtual machine, is not directly connected to the cluster node 510. However, the virtual-machine node 520 is indirectly connected to the cluster node 510 via the host node 515. Thus, the cluster node 510 and the virtual-machine node 520 may be said to be in a grandparent-grandchild relationship. Therefore, from the entity relationship graph 500, the relationships between various entity nodes may be ascertained. As also discussed above, each entity node may have associated therewith one or more activity nodes. The entity relationship graph 500 does not show any activity nodes for simplicity of explanation. However, FIG. 6 shows a portion of the entity relationship graph 500 in which certain entity nodes are shown with one or more activity nodes.

Although a single instance of each of the multi cluster node 505, the cluster node 510, the host node 515, the virtual-machine node 520, the virtual-disk node 525, the protection-domain node 530, the container node 535, the network interface card node 540, the disk node 545, and the storage pool node 550 are shown in FIG. 5, in other embodiments, multiple instances of one or more of those nodes depending upon the configuration of the virtual computing system 100 may be present. Further, in some embodiments, not all of the entity nodes that are shown in FIG. 5 may be present. Again, the entity nodes that are provided within the entity relationship graph 500 and the relationship between those entity nodes may vary based upon the components present within the virtual computing system 100 and the relationship between those components.

Referring to FIG. 6 in conjunction with FIGS. 3-5, an entity relationship graph 600 is shown, in accordance with some embodiments of the present disclosure. The entity relationship graph 600 includes both entity nodes and activity nodes. For example, the entity relationship graph 600 shows a cluster node 605, a host node 610, and a virtual machine node 615—all of which are entity nodes. The entity relationship graph 600 also includes activity nodes. For example, the cluster node 605 is shown to have an actions node 620, a metrics node 625, an alerts node 630, and an attributes node 635—all of which are activity nodes. In other embodiments, the cluster node 605 may have fewer, additional, or different activity nodes. Further, it is to be understood that the features noted in the each of the activity nodes in FIG. 6 are simply an example. In other embodiments, the features within each activity node may vary.

Similarly, although the virtual machine node 615 is shown to have four activity nodes including an actions node 640, an alerts node 645, an attributes node 650, and a metrics node 655, in other embodiments, the virtual machine node may have fewer, additional, or different activity nodes. Also, although the host node 610 is not shown as having any activity nodes, in other embodiments, the host machine node may be configured with one or more activity nodes. Likewise, any other entity nodes within the entity relationship graph 600 may include one or more activity nodes.

By reviewing and/or analyzing the activity nodes associated with a particular entity node, additional information pertaining to that entity node may be gleaned. For example, by looking at the actions node 620 of the cluster node 605, it may be determined what actions the cluster associated with the cluster node 605 may perform. For example, as noted in the actions node 620, the cluster associated with the cluster node 605 may configure settings of the cluster and possibly of the various components within the cluster. Similarly, as noted by the actions node 640 of the virtual machine node 615, the virtual machine associated with the virtual machine node may take various actions related to creating, powering-off, cloning, and migrating.

Likewise, the alerts node 645 of the virtual machine node 615 lists the various alerts that are being raised by the virtual machine associated with the virtual machine node. For example, the alerts node 645 of the virtual machine node 615 shows a CPU related alert being issued from the virtual machine associated with the virtual machine node. In some embodiments, the alerts node 645 may be configured to show only those alerts that are currently being raised by the associated entity. In other embodiments, the alerts node 645 may be additionally or alternatively configured to show alerts that were raised previously within a given amount of time. Further, in some embodiments, the alerts node 645 may only show what alerts are being raised by the associated entity, but may not show any additional details associated with that alert. In other embodiments, the alerts node 645 may also show the additional details associated with the alerts. For example, the alerts node 645 shows a CPU related alert. In some embodiments, the alerts node 645 may also show what type of CPU alert (e.g., related to utilization, latency, etc.) is being raised and the values associated with that alert.

The alerts node 630 of the cluster node 605 is shown as being empty. This may suggest that no alerts are being issued currently by the associated cluster or that no alerts have been issued by the cluster in a predetermined period, as the case might be based upon the configuration of the alerts node. An “alert” as used herein means a warning, alarm, notification, or event that is raised by the underlying entity to identity one or more issues or adverse events being experienced by that underlying entity. In some embodiments, the alerts may be color coded. For example, a yellow color coded alert may mean a warning or non-critical event and a red color coded alert may mean a critical event requiring immediate attention. Various other features may be associated with the alerts.

Similar to the alerts node 630 and 645, the other activity nodes may be configurable. For example, as the actions that an associated entity may make are varied, the configuration of the actions node may be varied to correctly reflect those actions. Thus, the activity nodes may be configurable. By reviewing the information within the activity nodes, various kinds of information pertaining to the associated entity may be easily determined.

Returning back to FIG. 3, the related entity finder 320 identifies the related entities of each primary entity identified by the result manager 305. The related entity finder 320 refers to the entity relationship graph 500 to identify the related entities. What constitutes a “related entity” may vary from one embodiment to another. In some embodiments, a related entity may be one that is directly connected to the primary entity in the entity relationship graph. In some embodiments, the direct connection relationship may be further limited to only parent-child relationships, only sibling relationships, or both. In other embodiments, a related entity may be one that is removed from the primary entity by a given number of nodes. For example, in some embodiments, nodes separated by another node in between (e.g., in a grandparent-grandchild relationship) may be considered for finding related entities. In other embodiments, greater separation of nodes may be considered for finding related entities. Thus, what constitutes a related entity may vary from one embodiment to another.

Further, what constitutes a related entity may be system defined and/or user defined. For example, in some embodiments, the user running the search query may be allowed to define what entities are considered to be related. In other embodiments, the result manager 305 or any other component within the virtual computing system 100 may define what entities are considered to be related. In some embodiments, the system may assign a default definition of what constitutes as “related,” and the user may be allowed to change that definition. Based upon the definition of the related entities, the related entity finder 320 finds the related entities of each primary entity from the entity relationship graph 500. For example, in the example discussed above in which the search query “V1 latency” is transformed into a primary structured query <Entity Type (Virtual Machine), Entity (V1), Activity Type (latency)> and <Entity Type (Virtual Disk), Entity (V1), Activity Type (latency)>, the related entity finder 320 finds related entities of both the V1 virtual machine and the V1 virtual disk.

Specifically, the related entity finder 320 may access the entity relationship graph 500 and find the entity node that corresponds to the V1 virtual machine. In some embodiments, the related entity finder 320 may identify the entity node corresponding to the V1 virtual machine by reviewing the attributes (or other activity nodes) associated with the various entity nodes and searching for a virtual machine having an attribute (e.g., name) of V1. The entity node corresponding to that activity node is then the entity node for the V1 virtual machine. After identifying the V1 virtual machine in the entity relationship graph 500, the related entity finder 320 may look for the entity nodes connected to the V1 virtual machine and that satisfy the definition of a related entity. For example, if the related entities are limited to siblings and parent of the V1 virtual machine, the related entity finder 320 may find other virtual machines connected to the V1 virtual machine in a sibling relationship (e.g., all siblings share the same parent node). The related entity finder 320 may also determine a host machine entity node as a parent node of the V1 virtual machine. Similarly, from the entity relationship graph 500, the related entity finder 320 may find the related entities for the V1 virtual disk.

In some embodiments, the definition of a related entity may vary based upon the entity type. For example, in some embodiments, the definition of a related entity for a cluster may be different from the definition of a related entity for a virtual machine, and so on. Upon gathering all of the related entities corresponding to the primary entity, the related entity finder 320 may provide the list of related entities to the related results generator 315. In some embodiments and specifically in those embodiments, in which the entity counter 265 tracks the popularity of the related entities, the related entity finder 320 may provide the identity of the related entities to the entity counter. In some embodiments, the related entity finder 320 may directly provide the identity of the related entities to the entity counter 265. In other embodiments, the related entity finder 320 may provide the identity of the related entities to the result manager 305 (or another component of the search computing system 200), which may then transfer that information to the entity counter 265.

Thus, the related results generator 315 receives the identity of the related entities from the related entity finder 320. The related results generator 315 also receives the one or more activity types from the result manager 305 (or possibly the related entity finder 320). The one or more activity types may be the same activity types that are used for gathering the search results in the primary results generator 310. Further, the related results generator 315 may be configured similar to the primary results generator 310 in that the related results generator may access the various databases within the virtual computing system 100 to gather search results from the related entities identified by the related entity finder 320.

Specifically, the related results generator 315 may access the activity nodes of the related entities in the entity relationship graphs and gather results from the activity nodes. In some embodiments, the result manager 305 may tell the related results generator 315 to gather search results pertaining to specific activity types. These activity types, as noted above, may be same as the activity types used for gathering search results from the primary entity. In some embodiments, in addition to or instead of gathering search results from the activity types used in the primary results generator 310, other activity types may be used for gathering the search results from the related entities. For example, in some embodiments, if the activity type used in the primary results generator 310 is directed towards alerts arising due to CPU utilization, the related results generator 315 may be configured to gather search results relating not only to CPU utilization, but to any alerts that may be arising from the related entities.

The performance of one entity may impact the performance of another related entity. Further, the cause of a problem at one entity may be caused by another problem at the related entity. For example, a latency problem at a first entity may be caused due to a CPU utilization problem at another entity. Thus, by gathering search results from activity types other than the activity types used by the primary results generator 310, information that may be valuable to a user and may provide clues into the problems occurring at a primary entity may be easily and conveniently provided.

Further, although the primary results generator 310 and the related results generator 315 are shown as different components in FIG. 3, in other embodiments, the primary results generator and the related results generator may be combined together into a single component. The related results generator 315 also provides the gathered results to the ranking system 325.

Thus, the ranking system 325 receives the search results corresponding to the primary entity (“primary search results”) from the primary results generator 310 and the related search results corresponding to the related entities (“related search results”) from the related results generator 315. The ranking system 325 ranks the primary search results and/or the related search results and provides those results to the search interface 205. The ranking system 325 may be configured to rank the search results in a variety of ways. For example, in some embodiments, the primary search results and the related search results may be combined together to generate combined search results and the combined search results may be ranked. In other embodiments, the primary search results and the related search results may be ranked separately. In yet other embodiments, combined search results, as well as either or both of the primary search results and the related search results may be ranked.

Additionally, in some embodiments, either or both of the primary search results and the related search results may be ranked according to one or more criteria before the results are returned to the user. The criteria that is used to rank the primary search results, the related search results, and/or the combined search results may be different for each category of search result. The criteria that is used for ranking may be system defined, user defined, or a combination of both. The criteria may be chronological, alphabetical, numerical, relevance, or any other ranking criteria that may be considered desirable.

In some embodiments, the ranking system 325 may additionally or alternatively be configured to rank the primary and/or related search results based upon a frequency in which those entities are searched. Thus, in some embodiments, search results from entities that are searched more frequently may be ranked higher than the search results of those entities that are not frequently searched. By virtue of ranking the more frequently ranked entities higher than the less frequently searched entities, the search computing system 200 attempts to predict the entities that the user may be interested in and make search results from those entities easily accessible and viewable by the user. If a user frequently searches for a particular entity, then chances of the user searching again for that entity are somewhat higher. Thus, by ranking and displaying the search results from the frequently searched entities higher than the less frequently searched entities, the search computing system 200 attempts to predict the intent of the user and return those results at the top that may be most pertinent to the user. Therefore, the user may run searches more efficiently and quickly.

Furthermore, as noted above, the various entities are connected either directly or indirectly to one another, and in some instances, problems or issues with a primary entity may be caused by a problem on a related entity. Thus, by virtue of finding related entities and returning results from the related entities, the search computing system 200 allows the user to quickly and conveniently find sources of problems within the virtual computing system 100 and address those problems quickly and conveniently.

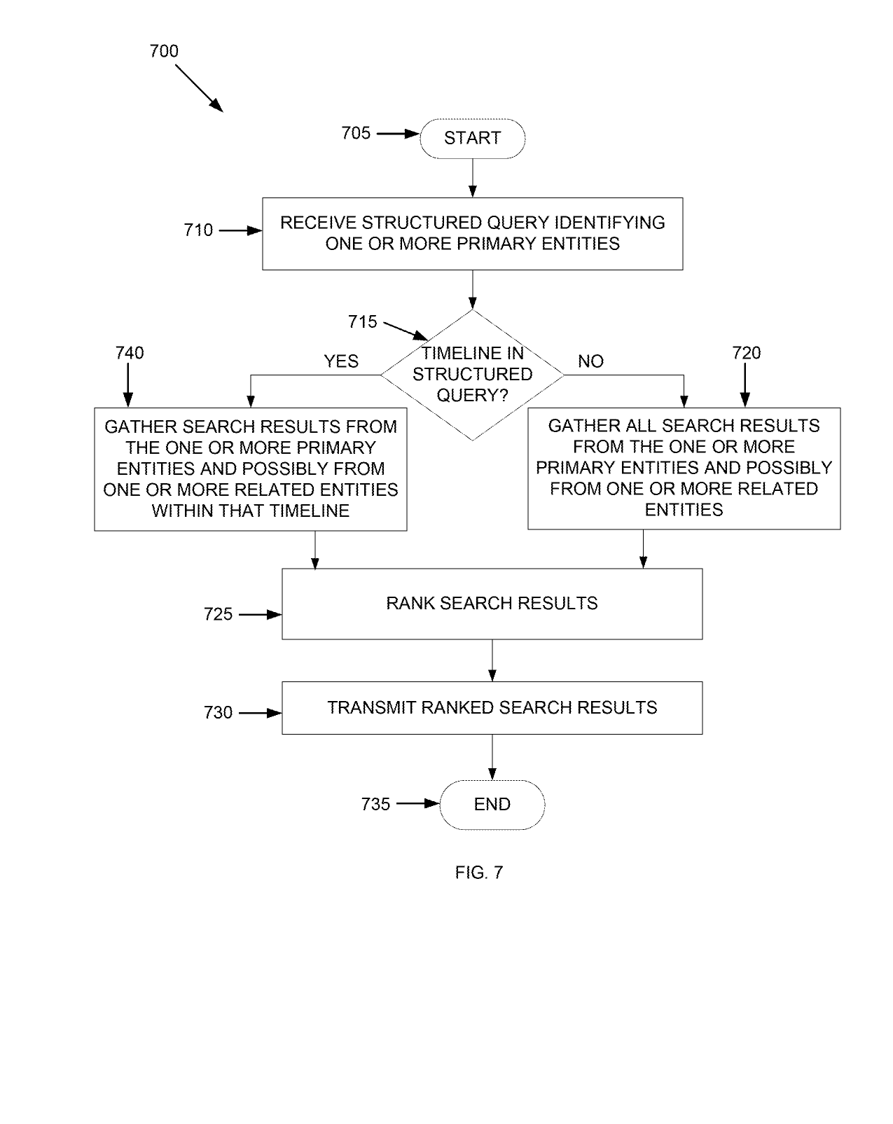

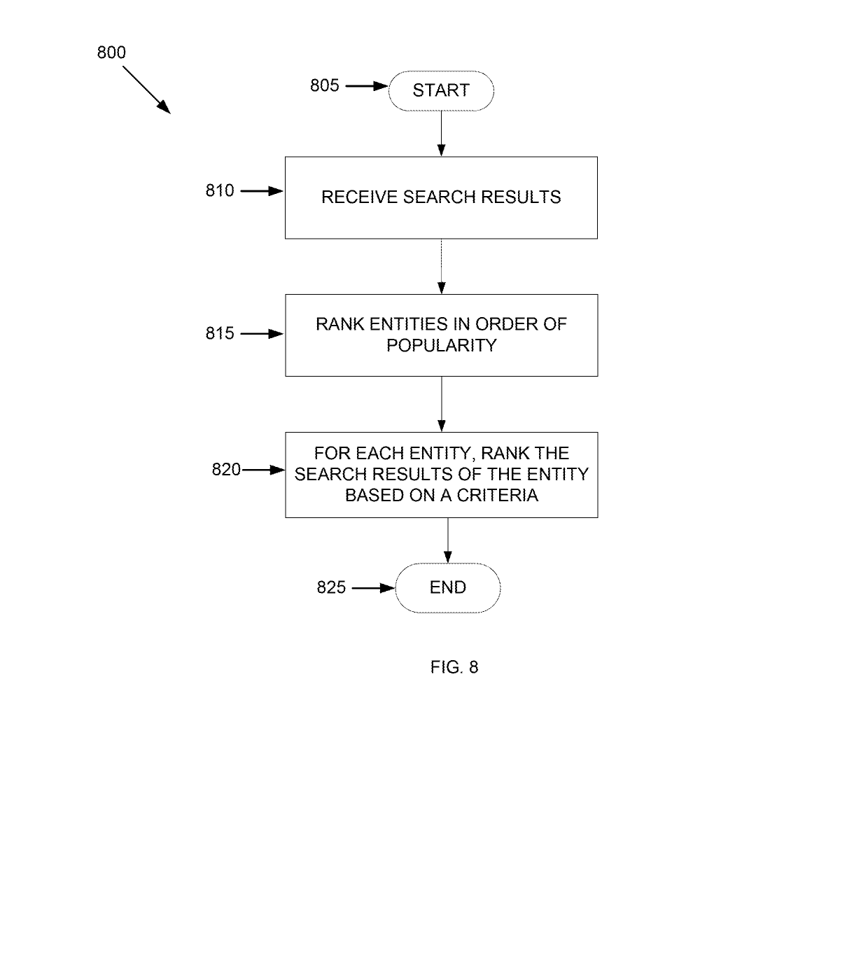

To rank search results based upon the frequency of searching, in some embodiments, the ranking system 325 includes a popular entity identifier 330. The popular entity identifier 330 may receive the counter values from the entity counter 265 of the search computing system 200. The popular entity identifier 330 may identify the primary and/or related entities with the highest count value and rank the search results starting with the primary entity with the highest count value at the top in a rank results block 335. The rank results block 335 may use a variety of criteria in ranking the search results. The ranking process is discussed below with respect to FIGS. 7 and 8.

Turning now to FIG. 7, a flowchart outlining a process 700 for generating and ranking search results in the result generator 300 is shown, in accordance with some embodiments of the present disclosure. The process 700 may include additional, fewer, or different operations, depending on the particular embodiment. After starting at operation 705, the result generator 300 receives a structured query at operation 710. As discussed above, the result manager 305 receives the structured query from the query parser 230. In some embodiments, the result manager 305 identifies the primary entity (or primary entities) from the structured query. The result manager 305 also identifies the one or more activity types associated with the primary entity (or primary entities).

In some embodiments, the result manager 305 may be configured to understand the format of the structured query and parse the structured query to extract the identity of the primary entity(ies) and activity type(s) from the structured query. Specifically, if the structured query is formatted such that the primary entity and the activity type are referenced in a particular way (e.g., prefixed, suffixed, or embedded between a particular variable or name), then the result generator may be configured to identify that particular variable or name, and identify the primary entity and activity type from those variables or names. For example, for a structured query such as <Entity Type (Virtual Machine or Virtual Disk), Entity (V1), Activity Type (latency)>, the result manager 305 may identify (e.g., by word matching) the variables “entity” and “activity type.” The result manager 305 may also be configured to understand that the value within the parenthesis following the variable “entity” is the primary entity and the value within the parenthesis following the variable “activity type” is the activity type for the identified primary entity.

Again, the format of the structured query discussed herein is simply an example for purposes of explanation. The actual format of the structured query may vary. In those embodiments in which the structured query includes multiple primary entities and/or multiple activity types, the result manager 305 may be configured to identify the multiple primary entities and/or the multiple activity types.

In some embodiments and as discussed above, the search computing system 200 may be configured such that in addition to or instead of sending the structured query to the result manager 305, the query parser 230 may simply send the identity of the primary entity(ies) and activity type(s) to the result manager. Since the query parser 230 is already identifying the primary entity(ies) and activity type(s) for the result manager 305, sending the primary entity(ies) and activity type(s) to the result manager may save computational resources at the result manager, as well as save time and reduce the complexity of the search computing system. In yet other embodiments, the result generator 300 may directly receive the search query input by the user and generate the structured query itself, as well as identify the primary entity(ies) and activity type(s) from the structured query. Thus, the result manager 305 may be configured in a variety of ways depending upon the configuration that is desired.

At operation 715, the result manager 305 determines whether a timeline is associated with the structured query. “Timeline” as used herein means a date, time, or any temporal indication within the search query. In some embodiments, the search query and therefore the structured query may specify a date and/or time of interest. For example, the search query may say something like “V1 slow between 2 PM and 4 PM” or “V1 slow on April 9” or “latency less than 4 seconds between 2 PM and 4 PM,” etc. When the search query includes a timeline, the structured query that is generated from that search query also includes the timeline. In some embodiments, the timeline may be included as part of the activity type in the structured query. In other embodiments, other ways of incorporating the timeline in the structured query may be used.

Further, in those cases in which the result manager 305 receives the structured query from the query parser 230, the result generator may be configured to identify the timeline from the structured query as well in addition to identifying the primary entity and the activity type. In those embodiments in which the result manager 305 only receives the identity of the primary entity and the activity type, the result generator may also receive the timeline from the query parser 230.

If the result manager 305 identifies that a timeline is not present or if the result manager does not receive a timeline from the query parser 230, then the result generator gathers all search results without regard to any timeline. Thus, at operation 720, the result manager 305 gathers the search results from each primary entity and each activity type identified at the operation 710. In some embodiments and as discussed above, to gather the search results from a particular primary entity, the result manager 305 provides the identity of the primary entity and the activity type associated with that primary entity to the primary results generator 310. The primary results generator 310 may analyze the entity relationship graphs discussed above to gather the data corresponding to the activity type. In other embodiments, the primary results generator 310 may not access the entity relationship graphs, but rather may directly access any log files associated with the primary entity and gather the data corresponding to the activity type from those log files. The primary results generator 310 may use other mechanisms to gather the search results from the primary entity.

Further, as discussed above, the result manager 305 gathers search results from the primary entity, as well as the related entities. In some embodiments, the result manager 305 may be configured to gather the search results from both the primary entity and the related entities every single time by default. In such embodiments, the result manager identifies (or receives identity of) the primary entity and finds the related entities of the primary entity. The result manager 305 then gathers data from the related entities as well. In other embodiments, the result manager 305 may be configured to gather search results from the related entities only in certain circumstances. Thus, in such embodiments, the result manager 305 gathers data from the primary entity by default and gathers data from the related entities only if a specific criteria is met. For example, in some embodiments, the result manager 305 may be configured to identify the related entities and gather data from the related entities only when no specific alerts or results pertaining to the activity type (e.g., the activity type identified at the operation 710 of FIG. 7 above) are found from the primary entity. In other embodiments, other criteria may be used by the result manager 305 to determine when to identify and search the related entities.

In the embodiments in which the search results from the related entities are gathered, the result manager 305 identifies the identity of the related entities before gathering the search results from the related entities. As discussed above, the result manager 305 provides the identity of the primary entity to the related entity finder 320, which then analyzes the entity relationship graphs to find the related entities. The related entity finder 320 may provide the identity of the related entities to the related results generator 315, which then gathers data from the related entities.

Also, in some embodiments, the related results generator 315 may gather data from the related entities only pertaining to the activity type identified for the primary entity at the operation 710. In such cases, the related results generator 315 may also receive the identity of the activity type from the result manager 305. In other embodiments, the related results generator 315 may gather any data (e.g., data in addition to or instead of data pertaining to the activity type of the primary entity) that may indicate any problems that may currently be happening or may have happened in the past within a predetermined duration at the related entities. For example, the related results generator 315 may look for any alerts that the related entities may either be currently generating or may have generated in the past within the predetermined duration.

Thus, upon gathering all of the data from the primary entity, the primary results generator 310 transfers the primary search results to the ranking system 325 at operation 725. Similarly, the related results generator 315 transfers the related search results from the related entities to the ranking system 325 at the operation 725. Upon receiving the primary search results and the related search results, the ranking system 325 ranks the primary search results and the related search results and returns the ranked search results to the user at operation 730. The process 700 ends at operation 735.

Referring still to FIG. 7, if at the operation 715, the result manager 305 determines that a timeline was associated with the structured query or if the result manager received a timeline from the query parser 230, the result manager gathers only those search results that satisfy that timeline at operation 740. Specifically, the result manager 305 may provide the identity of the primary entity, the activity type, as well as the timeline to the primary results generator 310. The primary results generator 310 may then gather data from the primary entity that matches that timeline. For example, if the timeline states between 2 PM and 4 PM, the primary results generator 310 gathers data from between 2 PM and 4 PM only. In some embodiments, the primary results generator 310 may be able to identify which data to gather (e.g., which data satisfies the timeline) by analyzing a time stamp that may be associated with that data. For example, when an alert is issued, a time stamp may be associated with that alert specifying the day and time at which the alert was generated. By reviewing the time stamp, the primary results generator 310 may gather the data that satisfies the timeline.

Also, as discussed above with respect to the operation 720, the result manager 305 may also identify the related entities and gather the search results from those related entities. Further, in some embodiments, the result manager 305 and particularly the related results generator 315 may gather only that data that satisfies the timeline identified at the operation 715. For example, if the timeline states between 2 PM and 4 PM, then the related results generator 315 looks for any problems (e.g., any alerts issued) between 2 PM and 4 PM from the related entities. In other embodiments, the result generator 300 may be configured such that the timeline only applies to the search results obtained from the primary entity and not to the search results from the related entities.

Additionally, in some embodiments, if the timeline specifies a particular date, as well as a time (e.g., April 9, between 2 PM and 4 PM), then the primary results generator 310 and/or the related results generator 315 look for data that satisfy both the date and time mentioned in the timeline. If the timeline only mentions the time but no date, then the primary results generator 310 and/or the related results generator 315 look for data that satisfies that time for a predetermined number of days (e.g., look for data between 2 PM and 4 PM for the past 30 days, including today). Likewise, if the timeline specifies a date, but no specific time limit, then the primary results generator 310 and/or the related results generator 315 may be configured to look for data within a predetermined number of hours on that date. For example, the primary results generator 310 and/or the related results generator 315 may be configured to look for data within a twelve hour period or a twenty four hour period on the date specified in the timeline.

Thus, the primary results generator 310 and/or the related results generator 315 may be configured in a variety of ways to specifically identify data that matches the specified timeline. In some embodiments, the configuration of the primary results generator 310 and the related results generator 315 may vary from one another. For example, in some embodiments, the primary results generator 310 may be configured to look for data within a twelve hour period on a specific date (e.g., when only date is specified in the timeline) and the related results generator 315 may be configured to look for data within a twenty four hour period. Thus, the configuration of the primary results generator 310 and the related results generator 315 may vary as desired.

On gathering the search results matching the timeline at the operation 740, the primary results generator 310 and the related results generator 315 provide their results to the ranking system 325 at the operation 725. The ranking system 325 ranks the search results and transmits the search results to be displayed at the operation 730. Again, the process 700 ends at the operation 735 with the result generator 300 waiting for the next structured query (or the next primary entity/activity type).

Turning now to FIG. 8, a flowchart outlining a ranking process 800 is shown, in accordance with some embodiments of the present disclosure. The ranking process 800 may include additional, fewer, or different operations, depending on the particular embodiment. After starting at operation 805, the ranking system 325 receives the search results at operation 810. Specifically, the ranking system 325 receives the primary search results from the primary results generator 310. If the result manager 305 gathered results from the related entities, then the ranking system 325 also receives the related search results from the related entities at the operation 810.

At operation 815, the ranking system 325 optionally ranks the primary entities associated with the primary search results and/or the related entities associated with the related search results in order of popularity. Specifically, in some embodiments, the ranking system 325 may rank the primary entities associated with the primary search results in order of popularity (e.g., for identifying which primary entities are most commonly searched). In other embodiments, in addition to or instead of determining the popularity of the primary entities, the ranking system 325 may rank the related entities associated with the related search results in order of popularity. In other embodiments, the ranking system 325 may combine the popularity ranking the primary entities and the related entities to simply identify the most popular entities. Furthermore, the ranking system 325 is configured to rank only those entities that are associated with the primary search results and the related search results. For example, in some embodiments, the primary search results and the related search results may identify the primary entities and related entities, respectively, that are associated with the search results. In other embodiments, other mechanisms of associating the primary search results with the respective primary entities and associating the related search results with the respective related entities may be used.

For ranking the primary and/or related entities at operation 815, the ranking system 325 and particularly, the popular entity identifier 330 of the ranking system uses the counter values from the entity counter 265 of the query parser 230. For example, in some embodiments, the popular entity identifier 330 may be operably coupled to the entity counter 265. Upon receiving the primary search results and/or related search results, the ranking system 325 (e.g., the popular entity identifier 330) may first identify the primary entities and/or related entities that correspond to the primary search results and/or the related search results, respectively. For example, if the popular entity identifier 330 is configured to only rank the primary entities in order of popularity, then the ranking system may identify only the primary entities associated with the primary search results. On the other hand, if the popular entity identifier 330 is configured to rank both the primary entities and the related entities, then the popular entity identifier 330 may identify both the primary entities and the related entities from the primary search results and the related search results, respectively.

The popular entity identifier 330 may request the counter value data from the entity counter 265 for the identified primary entities and/or the related entities. In some embodiments, the entity counter 265 may provide the entire counter data to the popular entity identifier 330 and the popular entity identifier may sift through the data to identify the counters for the primary entities and/or related entities that are of interest. In other embodiments, the entity counter 265 may provide the counter data of only those primary entities and/or related entities that the popular entity identifier 330 has requested. In some embodiments, the popular entity identifier 330 and the entity counter 265 may be combined together into a single component.

Upon identifying the counters associated with the primary entities and/or related entities that are of interest, the popular entity identifier 330 may identify the most popular primary entity, most popular related entity, and/or most popular entity (whether primary or related) based upon how the popular entity identifier is configured. For example, the popular entity identifier 330 may determine which counter has the highest value and the entity associated with the counter having the highest value is the most popular entity. Thus, the popular entity identifier 330 may rank all of the entities from most popular to least popular. For each entity in the ranking, starting with the most popular entity, the rank results block 335 of the ranking system 325 may rank the search results associated with that entity at operation 820.

Say for example, entity 1 is the most popular entity. The rank results block 335 may rank the search results associated with entity 1 according to a particular criteria. For example, in some embodiments, the rank results block 335 may rank the search results associated with entity 1 such that the most recent search result (e.g., search result having the most recent time stamp) is listed at the top. In other embodiments, the rank results block 335 may rank the results such that a most critical search result is displayed at the top. As noted above, an alert may be identified as critical or non-critical from the color associated the alert. Thus, embodiments in which a red color alert is considered a critical alert and a yellow color alert is considered a non-critical alert, red alerts may be ranked higher than the yellow alerts. If the criticality information of the other search results is available, those search results may be similarly ranked. If some search results have criticality information associated therewith and other search results have no criticality information associated therewith, then the search results with the criticality information may be ranked at the top with the most critical search results at the top followed by a ranking (using a desired criteria) of the non-critical search results.

In yet other embodiments, other criteria as desired may be used for ranking the search results for entity 1. Also, as alluded to above, the rank results block 335 may be configured such that certain ranking criteria (e.g., criticality information) are given preference over other criteria (e.g., time). Further, in some embodiments, multiple ranking criteria may be combined such that multiple levels of ranking may be used. For example, for the rank results block 335 ranking by both criticality and time, the search results may be ranked such that the most critical search results are displayed at the top followed by the non-critical search results. Further, within each of the critical results subset and the non-critical results subset, the search results may be arranged by their of time of occurrence such that a most recently occurring search result (e.g., the most recent alert) is displayed at the top of the ranking list. Thus, the rank results block 335 may be configured to rank the search results of entity 1 in a variety of ways.

The rank results block 335 may similarly rank the search results of the other entities. Further, in some embodiments, the rank results block 335 may be configured to provide multiple lists of the ranked search results. For example, one list could pertain to the ranked search results from the primary entities only. In such a list, the rank results block 335 may include a first level ranking in which the primary entities are arranged by the order of popularity. The list may have a second level of ranking in which for each entity, the search results pertaining to that entity are additionally ranked and arranged in a particular order (e.g., by criticality, by time, etc.). Another list may be similarly structured for the search results from the related entities only. Yet another list may be structured for the combined search results of the primary entities and the related entities.

In some embodiments, the rank results block 335 may simply rank all the search results (primary and related search results individually and/or combined) by a criteria (e.g., criticality, time, etc.) without first ranking the entities by popularity. By virtue of ranking all of the search results, search results that may otherwise be ranked lower may now be displayed higher on the list of ranked results. For example, when the entities are first ranked by popularity, if the entity 1 is ranked lower on the popularity ranking of the entities, then an alert arising from entity 1 even if more critical than an alert arising from a more popular entity is ranked lower. By ranking all the search results without first ranking the entities by popularity, if criticality is used as a criteria, the alert from entity 1 may be ranked higher.

In sum, the rank results block 335 may be configured to provide a first level of ranking in which the entities are ranked first by popularity and a second level of ranking in which search results from each entity are further ranked while maintaining the popularity ranking from the first level. In other embodiments, additionally or alternatively, the rank results block 335 may be configured to simply rank the search results based on a criteria without first ranking the entities by popularity. The rank results block 335 may be configured to rank the search results in other ways too. Thus, the rank results block 335 may be configured in a variety of ways. The rank results block 335 may transmit the ranked search results to the search interface 205, as discussed in FIG. 7 above. The ranking process 800 ends at operation 825.

Thus, the present disclosure provides a system and method for gathering and ranking search results from one or more primary entities and one or more related entities. By gathering data from both primary and related entities and by ranking the search results, troubleshooting, work flow, exploration, or other related tasks may be performed quicker and with ease.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
identifying, by a search computing system, a primary entity from a search query;
determining, by the search computing system, a related entity from the primary entity; and
returning, by the search computing system, search results associated with the primary entity and the related entity, wherein the search results are arranged in an order of popularity of the primary entity and the related entity, and wherein the search results are further arranged based upon a criterion within the order of popularity.

2. The method of claim 1, further comprising identifying the related entity from an entity relationship graph that comprises a plurality of entity nodes arranged in a hierarchical relationship, wherein two adjacent entity nodes of the plurality of entity nodes are associated in one of a parent-child relationship and a sibling relationship.

3. The method of claim 2, wherein the related entity and the primary entity are part of the plurality of entity nodes and connected in the parent-child relationship.

4. The method of claim 2, wherein the related entity and the primary entity are part of the plurality of entity nodes and connected in the sibling relationship.

5. The method of claim 2, further comprising identifying, by the search computing system, an activity type from the search query, wherein the search computing system identifies an activity node corresponding to the activity type in the entity relationship graph for generating the search results.

6. The method of claim 1, wherein the search results comprise primary search results generated from the primary entity and related search results generated from the related entity.

7. The method of claim 1, further comprising determining the order of popularity based upon a count value of a first counter associated with the primary entity and a second counter associated with the related entity.

8. The method of claim 7,
wherein the count value of the first counter is incremented each time the primary entity is encountered in search queries, and wherein the count value of the second counter is incremented each time the related entity is identified from the search queries.

9. The method of claim 7, further comprising comparing the count value of the first counter and of the second counter such that the primary entity or the related entity associated with a higher count value is more popular.

10. The method of claim 1, wherein the criterion comprises an indication of criticality, and wherein the search results indicated as more critical are ranked higher than the search results indicated as less critical.

11. The method of claim 1, wherein the criterion comprises an indication of time, and wherein the search results that are more recent in time are ranked higher than other ones of the search results.

12. An apparatus, comprising:
a processing unit having computer-executable instructions embodied thereon that cause the processing unit to:
identify a primary entity from a search query;
determine a related entity from the primary entity; and
return search results associated with the primary entity and the related entity, wherein the search results are arranged in an order of popularity of the primary entity and the related entity, and wherein the search results are further arranged based upon a criterion within the order of popularity.

13.-14. (canceled)

15. The apparatus of claim 12, wherein the processing unit accesses an entity relationship graph to identify the related entity, wherein the entity relationship graph comprises a plurality of entity nodes connected in a hierarchical relationship, and wherein each of the plurality of entity nodes represents a component within a virtual computing system that can be queried.

16. The apparatus of claim 12, wherein the processing unit assigns a first counter to the primary entity and a second counter to the related entity, and wherein the processing unit compares a count value of the first counter and of the second counter to determine the order of popularity of the primary entity and the related entity.

17. The apparatus of claim 12, wherein the criterion comprises criticality or time.

18. A method comprising:
identifying, by a search computing system, a primary entity and a timeline from a search query;
determining, by the search computing system, a related entity from the primary entity;
generating, by the search computing system, search results from the primary entity and the related entity satisfying the timeline; and
returning, by the search computing system, the search results associated with the primary entity and the related entity, wherein the search results are arranged in an order of popularity of the primary entity and the related entity, and further arranged based on a criterion within the order of popularity.

19. The method of claim 18, further comprising:
identifying, by the search computing system, the primary entity in an entity relationship graph; and
identifying, by the search computing system, the related entity as an entity related to the primary entity in the entity relationship graph.

20. The method of claim 18, wherein the criterion comprises an indication of criticality or time.

21. The method of claim 18, further comprising comparing a count value of a first counter associated with the primary entity and a count value of a second counter associated with the related entity to determine the order of popularity.

22. The method of claim 18, wherein the search results corresponding to a more popular one of the primary entity or the related entity are displayed higher.
